(19) United States
(12) Patent Application Publication
(10) Pub. No.: US 2017/0158163 A1
(43) Pub. Date: Jun. 8, 2017

(54) VEHICLE HOOD

(71) Applicant: Kabushiki Kaisha Kobe Seiko Sho (Kobe Steel, Ltd.), Kobe-shi (JP)

(72) Inventors: Masatoshi YOSHIDA, Kobe-shi (JP); Hiroko KASHIMA, Kobe-shi (JP)

(73) Assignee: Kabushiki Kaisha Kobe Seiko Sho (Kobe Steel, Ltd.), Kobe-shi (JP)

(21) Appl. No.: 15/346,012

(22) Filed: Nov. 8, 2016

(30) Foreign Application Priority Data
Dec. 4, 2015 (JP) 2015-237317
Jul. 11, 2016 (JP) 2016-136806

(51) Int. Cl. B60R 21/34; B62D 25/12

(52) U.S. Cl. CPC B60R 21/34; B62D 25/12; B60R 2021/343

(57) ABSTRACT

There is provided a vehicle hood capable of decreasing a HIC score at each side in a breadth direction. A vehicle hood includes an outer panel and an inner panel, in which the inner panel includes a bead bottom and a plurality of beads; the bead bottom includes an outermost bottom that is located on an outermost side in a breadth direction and has a shape extending in a longitudinal direction, and an inner bottom that is located inside the outermost bottom and has a shape extending in the longitudinal direction; the beads include a lateral bead having a shape extending in the longitudinal direction between the outermost bottom and the inner bottom; and the lateral bead includes an outermost vertical wall, an inner vertical wall, and an outermost opposing part.

### BACKGROUND

The present invention relates to a vehicle hood having an inner panel and an outer panel.

A vehicle hood is in general required to have front collision performance for vehicle-to-vehicle collision and pedestrian protection performance, for example. In the vehicle hood having the inner panel and the outer panel, a plurality of linear beads are often provided on the inner panel in order to provide such types of performance together. For example, Japanese Unexamined Patent Application Publication No. 2012-214076 (JP-A-2012-214076) discloses a vehicle hood having the inner panel and the outer panel, in which the inner panel has a plurality of beads each having a shape extending along a breadth direction. Each bead has a vertical wall rising from a bottom of the inner panel and a mastic seat that is coupled to the upper end of the vertical wall and is opposed to the lower surface of the outer panel.

A shape of each of such beads is designed such that a so-called head injury criterion (HIC) score satisfies a predetermined criterion. Specifically, to satisfy the criterion, it is effective that the absorption amount of collision energy is increased to the utmost in an early stage of head collision to the vehicle hood (outer panel), i.e., an acceleration primary peak is increased in an early stage of collision, and an acceleration secondary peak is decreased in the latter half of collision.

In the vehicle hood described in JP-A-2012-21407, collision energy to the outer panel is transmitted from a collision point to either side in the breadth direction via each bead, i.e., a load is received by a large-area region in the inner panel; hence, the acceleration primary peak is increased. In the latter half of collision, when the inner panel comes into contact with an internal component (such as an engine) of a vehicle body, the inner panel efficiently absorbs the rest of the collision energy while being crushed, and thus the acceleration secondary peak is decreased.

### SUMMARY

Recently, the vehicle hood is required to be improved in pedestrian protection performance (decreased in HIC score) at each side in the breadth direction of the vehicle hood in addition to at the middle of the vehicle hood. However, the vehicle hood described in JP-A-2012-214076 is difficult to meet such a demand. Specifically, the vehicle hood of JP-A-2012-214076 is difficult to be increased in acceleration primary peak at each side in the breadth direction. In detail, for the vehicle hood of JP-A-2012-214076, since collision energy at the middle of the vehicle hood is transmitted from a collision point to either side in the breadth direction via each bead, the acceleration primary peak can be increased. However, since the transmission direction of collision energy is substantially limited to a direction from the side to the middle at each side in the breadth direction, the acceleration primary peak is difficult to be increased at the side.

An object of the invention is to provide a vehicle hood capable of decreasing the HIC score at each side in the breadth direction.

As a measure to solve the problem, the invention provides a vehicle hood including an outer panel and an inner panel disposed below the outer panel, in which the inner panel includes a bead bottom, and a plurality of beads each having a shape protruding from the bead bottom toward the outer panel, the bead bottom including an outermost bottom that is located on an outermost side in a breadth direction and has a shape extending in a longitudinal direction, and an inner bottom that is located inside the outermost bottom in the breadth direction and has a shape extending in the longitudinal direction, the beads including a lateral bead having a shape extending in the longitudinal direction between the outermost bottom and the inner bottom, the lateral bead including an outermost vertical wall having a shape rising from the outermost bottom toward the outer panel, an inner vertical wall having a shape rising from the inner bottom toward the outer panel, and an outermost opposing part that connects an upper end of the outermost vertical wall to an upper end of the inner vertical wall over the whole area in the longitudinal direction, and is opposed to a lower surface of the outer panel.

In the vehicle hood, collision energy to each side in the breadth direction is received by the outermost opposing part, and is transmitted over a longitudinal wide range via the outermost opposing part and the two vertical walls (the outermost vertical wall and the inner vertical wall), i.e., the collision energy to the side is received by a large-area region; hence, the acceleration primary peak can be increased. Consequently, the acceleration secondary peak is decreased in the latter half of collision, and the HIC score at each side in the breadth direction can be effectively decreased.

In such a case, it is preferred that the outermost vertical wall has a shape inclining toward an inner side in the breadth direction as running toward the outer panel from the outermost bottom; the inner vertical wall has a shape inclining toward an outer side in the breadth direction as running toward the outer panel from the innermost bottom; and a distance between the outermost opposing part and the outermost bottom is set to be smaller than a distance between the outermost opposing part and the inner bottom.

Thus, when the inner panel comes into contact with the internal component (such as an engine) of the vehicle body in the latter half of collision, the outermost vertical wall and the inner vertical wall are easily crushed, and the outermost opposing part can be provided on a more outer side in the breadth direction; hence, the HIC score at each side can be more effectively decreased. When the outer panel receives a shock, the inner vertical wall first comes into contact with the internal component of the vehicle body, the acceleration secondary peak value is effectively decreased by crush of the inner vertical wall.

Furthermore, in this case, it is preferred that an inclination angle of the outermost vertical wall to the outermost bottom is set to be larger than an inclination angle of the inner vertical wall to the inner bottom.

Thus, the outermost opposing part can be provided on a more outer side in the breadth direction; hence, the HIC score at each side can be more effectively decreased.

In the invention, it is preferred that a hinge fixation part fixing a hinge is provided in a rear corner of the inner panel, the hinge fixation part connecting the vehicle hood to the vehicle body; a cushion member seat fixing a cushion member is provided in a front corner of the inner panel; and the inner bottom has a shape that extends along a straight line connecting the hinge fixation part to the cushion member seat.

Thus, a linear inner bottom is formed between the hinge fixation part having a relatively high stiffness and the cushion member seat; hence, stiffness of the inner panel (for example, strength against a shock occurring when the vehicle hood is shut) is effectively provided.

In the invention, it is preferred that the inner vertical wall has a trim hole penetrating through the inner vertical wall.

Thus, since stiffness of the inner vertical wall is reduced, crush of the inner vertical wall is promoted when the inner vertical wall collides with the internal component in the latter half of collision. Consequently, collision energy in the latter half of collision can be effectively absorbed.

In the invention, it is preferred that the bead bottom further includes a most-front bottom that is located in the most front in the longitudinal direction and has a shape extending in the breadth direction, and a second-row bottom that is located behind the most-front bottom and has a shape extending in the breadth direction, in which the beads further include a most-front bead having a shape extending in the breadth direction between the most-front bottom and the second-row bottom, the most-front bead including a most-front vertical wall having a shape rising from the most-front bottom to the outer panel, a second-row vertical wall having a shape rising from the second-row bottom to the outer panel, and a most-front opposing part that connects the upper end of the most-front vertical wall to the upper end of the second-row vertical wall over the whole area in the breadth direction, and is opposed to the lower surface of the outer panel.

Thus, when the front end of the outer panel is pushed down toward the vehicle body, for example, when the vehicle hood is closed, a load exerted on the front end is received by the most-front opposing part, making it possible to omit a reinforcement member for reinforcing the front end of each of the inner panel and the outer panel. Consequently, cost reduction and reinforcement of the front end are achieved together.

In this case, it is preferred that a striker reinforcement member provided below the most-front opposing part is further provided.

In the invention, it is preferred that the outer bead further includes a front connection vertical wall that connects the front end of the outermost vertical wall to the front end of the inner vertical wall, and the most-front bead further includes a lateral connection vertical wall that connects a lateral end of the most-front vertical wall to a lateral end of the second-row vertical wall.

Thus, since part of the load exerted between the outer bead and the most-front bead is received by both the front connection vertical wall and the lateral connection vertical wall, stiffness of the inner panel is increased.

In the invention, it is preferred that the beads each have a shape extending along the breadth direction, and further include a plurality of central beads provided so as to be intermittently arranged in the longitudinal direction in the middle in the breadth direction.

Thus, the HIC score in the middle in the breadth direction is effectively decreased.

In this case, it is preferred that the beads further include a connection bead that connects lateral ends in the breadth direction of the central beads to one another.

Thus, the HIC score in the middle in the breadth direction is more effectively decreased.

In the invention, it is preferred that each of the inner panel and the outer panel is formed of aluminum, and strength of the inner panel is set to be smaller than strength of the outer panel.

In this way, according to the invention, it is possible to provide a vehicle hood capable of decreasing the HIC score at each side in the breadth direction.

### BRIEF DESCRIPTION OF THE DRAWINGS

FIG. 1 is a schematic view of an inner panel of a vehicle hood of a first embodiment of the invention.

FIG. 2 is a sectional view along a line II-II of FIG. 1.

FIG. 3 is a sectional view along a line of FIG. 1.

FIG. 4 is a schematic view of an inner panel of a vehicle hood of a second embodiment of the invention.

FIG. 5 is a sectional view along a line V-V of FIG. 4.

FIG. 6 is a schematic view of an inner panel of a vehicle hood of a third embodiment of the invention.

FIG. 7 is a schematic view of an inner panel of a vehicle hood of a comparative example.

FIG. 8 is a sectional view along a line VIII-VIII of FIG. 7.

FIG. 9 is a schematic illustration of hit points.

FIG. 10 illustrates a relationship between a collision angle and a gap between a vehicle hood and an internal component.

FIG. 11 is a graph illustrating a relationship between elapsed time from collision and acceleration at a hit point B.

FIG. 12 is a graph illustrating a relationship between a displacement stroke of an impactor and acceleration at the hit point B.

FIG. 13 illustrates a relationship between elapsed time from collision and acceleration at a hit point A.

FIG. 14 illustrates a relationship between a displacement stroke of an impactor and acceleration at the hit point A.

FIG. 15 is a schematic view of an evaluation method of torsional stiffness of an inner panel.

FIG. 16 is a schematic view illustrating a modification of central beads of the inner panel of the first embodiment.

FIG. 17 is a sectional view along a line XVII-XVII of FIG. 16.

FIG. 18 is a sectional view along a line XVIII-XVIII of FIG. 16.

FIG. 19 is a schematic view illustrating a modification of the central beads of the inner panel of the first embodiment.

FIG. 20 is a sectional view along a line XX-XX of FIG. 19.

FIG. 21 is a sectional view along a line XXI-XXI of FIG. 19.

### DETAILED DESCRIPTION

### First Embodiment

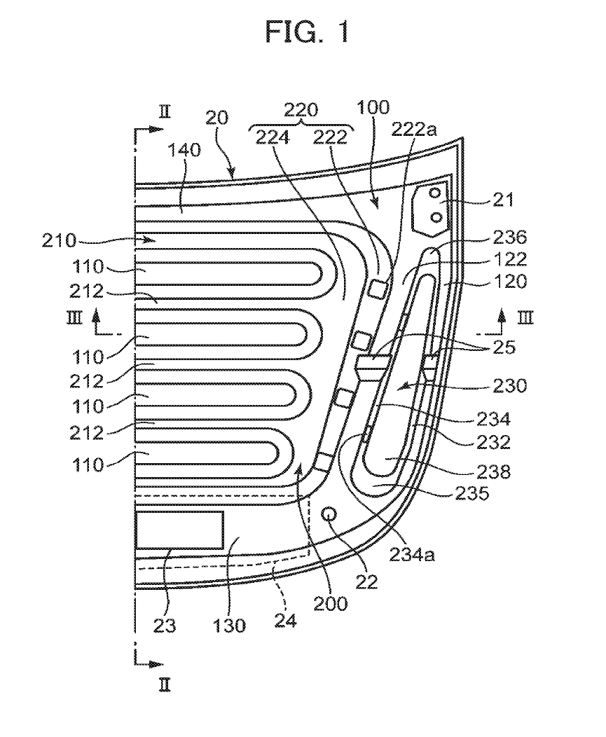

A vehicle hood of a first embodiment of the invention is now described with reference to FIGS. 1 to 3.

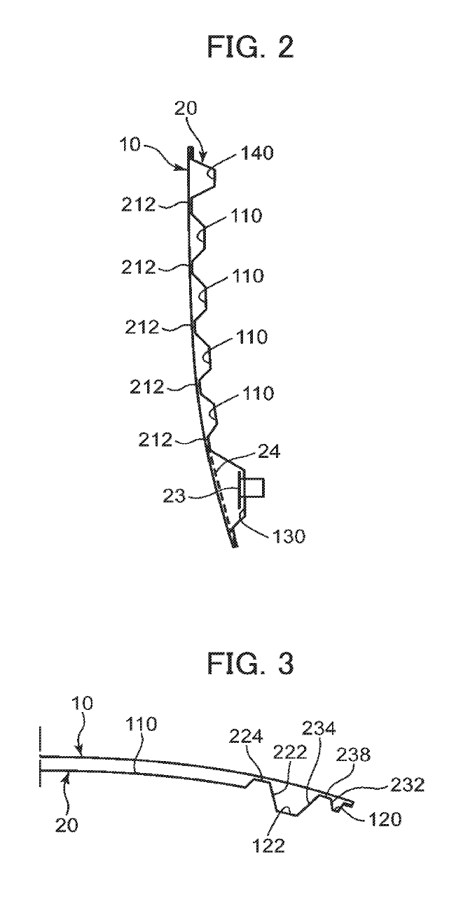

As illustrated in FIGS. 2 and 3, the vehicle hood includes an outer panel 10 and an inner panel 20 disposed below the outer panel 10. In FIG. 1, the outer panel 10 is not shown. Each of the outer panel 10 and the inner panel 20 has a symmetric shape in a breadth direction with reference to a plane that passes through the center in the breadth direction and is orthogonal to the breadth direction. Hence, FIG. 1 shows only a site on one side in the breadth direction with respect to the plane.

The outer panel 10 has a flat sheet shape formed of aluminum. Strength of the outer panel 10 is preferably set to 175 MPa or more in 0.2% proof stress. Thus, dent resistance is provided.

The inner panel 20 is formed of aluminum. Strength of the inner panel 20 is set to be smaller than the strength of the outer panel 10. Specifically, the strength of the inner panel 20 is preferably set to 125 MPa or less in 0.2% proof stress. Thus, when the inner panel 20 collides with an internal component (such as an engine) of the vehicle body, the inner panel 20 can efficiently absorb collision energy while being crushed. The strength of the inner panel 20 may be comparable to the strength of the outer panel 10. The inner panel 20 has a bead bottom 100 and a plurality of beads 200. The bead bottom 100 and the beads 200 are each formed by press forming of a sheet material including aluminum.

The bead bottom 100 is substantially flat. The bead bottom 100 includes a plurality of (four in the first embodiment) central bottoms 110, an outermost bottom 120, an inner bottom 122, a front bottom 130, and a rear bottom 140.

Each central bottom 110 has a shape linearly extending along the breadth direction. The central bottoms 110 are provided so as to be intermittently arranged at equal intervals in the middle in the breadth direction.

The outermost bottom 120 is located on an outermost side in the breadth direction and has a shape extending in the longitudinal direction.

The inner bottom 122 is located inside the outermost bottom 120 in the breadth direction (between the outermost bottom 120 and the central bottoms 110) and has a shape extending in the longitudinal direction.

The front bottom 130 is located in front of the central bottoms 110, and has a shape extending along the breadth direction.

The rear bottom 140 is located behind the central bottoms 110, and has a shape extending along the breadth direction.

The inner panel 20 has a hinge fixation part 21 and a cushion member seat 22. The hinge fixation part 21 is a part for fixing a hinge that connects the vehicle hood to the vehicle body. The hinge fixation part 21 is provided in a rear corner of the inner panel 20. The hinge fixation part 21 is provided on a surface located below a surface having the outermost bottom 120, the inner bottom 122, and the rear bottom 140 thereon. However, the hinge fixation part 21 may be provided on the same surface as the surface having the outermost bottom 120, the inner bottom 122, and the rear bottom 140 thereon. The cushion member seat 22 is a portion for fixing a cushion member such as cushion rubber. The cushion member seat 22 is provided in a front corner of the inner panel. The inner bottom 122 has a shape extending along a straight line connecting the hinge fixation part 21 to the cushion member seat 22.

The inner panel 20 has a striker reinforcement member 23 and a dent reinforcement member 24. As illustrated in FIG. 2, the striker reinforcement member 23 is disposed on the top of the front bottom 130. The dent reinforcement member 24 is disposed in a region opposed to the front bottom 130 in the back of the outer panel 10.

Each bead 200 has a shape protruding from the bead bottom 100 to the outer panel 10. The beads 200 include a plurality of central beads 210, a connection bead 220, and an outer bead 230.

Each central bead 210 has a shape protruding from each central bottom 110 and linearly extending along the breadth direction. The central bead 210 has a central opposing part 212 opposed to the back of the outer panel 10. The central opposing part 212 is bonded to the back of the outer panel 10 with a mastic adhesive. In other words, the central opposing parts 212 configure a mastic seat.

The connection bead 220 connects the lateral ends in the breadth direction of the central beads 210 to one another. The connection bead 220 has a shape extending in the longitudinal direction. The connection bead 220 includes a connection vertical wall 222 rising from the inner bottom 122, and a connection opposing part 224 that is coupled to the upper end of the connection vertical wall 222 and connects the lateral ends of the central opposing parts 212 to one another. The connection vertical wall 222 has a shape inclining toward an inner side in the breadth direction as running toward the outer panel 10. The connection vertical wall 222 has a plurality of (four in the first embodiment) trim holes 222a. Each trim hole 222a has a shape penetrating the connection vertical wall 222 in the through-thickness direction.

The outer bead 230 has a shape extending in the longitudinal direction between the outermost bottom 120 and the inner bottom 122. The outer bead 230 includes an outermost vertical wall 232, an inner vertical wall 234, a front connection vertical wall 235, a rear connection vertical wall 236, and an outermost opposing part 238

The outermost vertical wall 232 has a shape rising from the outermost bottom 120 to the outer panel 10. Specifically, the outermost vertical wall 232 has a shape inclining toward an inner side in the breadth direction as running toward the outer panel 10 from the outermost bottom 120.

The inner vertical wall 234 has a shape rising from the inner bottom 122 to the outer panel 10. Specifically, the inner vertical wall 234 has a shape inclining toward an outer side in the breadth direction as running toward the outer panel 10 from the inner bottom 122. As illustrated in FIG. 3, an inclination angle of the inner vertical wall 234 to the inner bottom 122 is set to be smaller than an inclination angle of the outermost vertical wall 232 to the outermost bottom 120. The inner vertical wall 234 has a plurality of (two in the first embodiment) trim holes 234a. Each trim hole 234a has a shape penetrating the inner vertical wall 234 in the through-thickness direction.

In the first embodiment, as illustrated in FIG. 1, a crush bead 25 is provided between the outermost vertical wall 232 and the outer edge of the inner panel and between the inner vertical wall 234 and the connection vertical wall 222.

The front connection vertical wall 235 connects the front end of the outermost vertical wall 232 to the front end of the inner vertical wall 234. The rear connection vertical wall 236 connects the rear end of the outermost vertical wall 232 to the rear end of the inner vertical wall 234.

The outermost opposing part 238 connects the upper end of the outermost vertical wall 232 to the upper end of the inner vertical wall 234 over the whole area in the longitudinal direction, and has a shape opposed to the lower surface of the outer panel. The front end of the outermost opposing part 238 is connected to the front connection vertical wall 235. The rear end of the outermost opposing part 238 is connected to the rear connection vertical wall 236. The outermost opposing part 238 is also a component of the mastic seat. As illustrated in FIG. 1, the outermost opposing part 238 has a shape that is increased in size in the breadth direction as running toward the front. As illustrated in FIG. 3, a distance between the outermost opposing part 238 and the outermost bottom 120 is set to be smaller than a distance between the outermost opposing part 238 and the inner bottom 122.

The outermost opposing part 238 is provided at a position overlapping with the central beads 210 in the breadth direction. Specifically, the rear end of the outermost opposing part 238 is located in front of an extension (a virtual line) formed by extending the central opposing part 212 of the central bead 210, which is located most rearward among the central beads 210, in the breadth direction. The front end of the outermost opposing part 238 is located behind an extension (a virtual line) formed by extending the central opposing part 212 of the central bead 210, which is located in the most front among the central beads 210, in the breadth direction.

As described above, in the vehicle hood of the first embodiment, collision energy to the side in the breadth direction is received by the outermost opposing part 238 and is transmitted to a wide region in the longitudinal direction via the outermost opposing part 238 and the two vertical walls (the outermost vertical wall 232 and the inner vertical wall 234), i.e., the collision energy to the side is received by a large-area region; hence, the acceleration primary peak can be increased. Consequently, the acceleration secondary peak is decreased in the latter half of collision, and thus the HIC score at each side in the breadth direction can be effectively decreased.

Since the outermost vertical wall 232 and the inner vertical wall 234 incline so as to be closer to each other as running toward the outer panel 10 from the bead bottom 100, when the inner panel 20 comes into contact with the internal component (such as an engine) of the vehicle body in the latter half of collision, the outermost vertical wall 232 and the inner vertical wall 234 are each easily crushed. Consequently, the acceleration secondary peak can be maintained to a low value; hence the HIC score at each side of the vehicle hood can be more effectively decreased.

Furthermore, since the distance between the outermost opposing part 238 and the outermost bottom 120 is set to be smaller than the distance between the outermost opposing part 238 and the inner bottom 122, the outermost opposing part 238 can be provided on a more outer side in the breadth direction. Consequently, the HIC score at each side can be more effectively decreased. When the outer panel 10 receives a shock, since the inner vertical wall 234 first comes into contact with the internal component of the vehicle body, the acceleration secondary-peak value is effectively decreased by crush of the inner vertical wall 234.

In addition, since the inclination angle of the outermost vertical wall 232 to the outermost bottom 120 is set to be larger than the inclination angle of the inner vertical wall 234 to the inner bottom 122, the outermost opposing part 238 can be provided on a more outer side in the breadth direction. Consequently, the HIC score at each side can be further effectively decreased.

Furthermore, the inner bottom 122 has a shape extending along a straight line connecting the hinge fixation part 21 to the cushion member seat 22. Specifically, the linear inner bottom 122 is formed between the hinge fixation part 21 having a relatively high stiffness and the cushion member seat 22; hence, stiffness of the inner panel 20 (for example, strength against a shock occurring when the vehicle hood is shut) is effectively provided.

Since the inner vertical wall 234 has the trim holes 234a, stiffness of the inner vertical wall 234 is reduced. Hence, crush of the inner vertical wall 234 is promoted when the inner vertical wall 234 collides with the internal component in the latter half of collision. Consequently, collision energy in the latter half of collision can be effectively absorbed.

### Second Embodiment

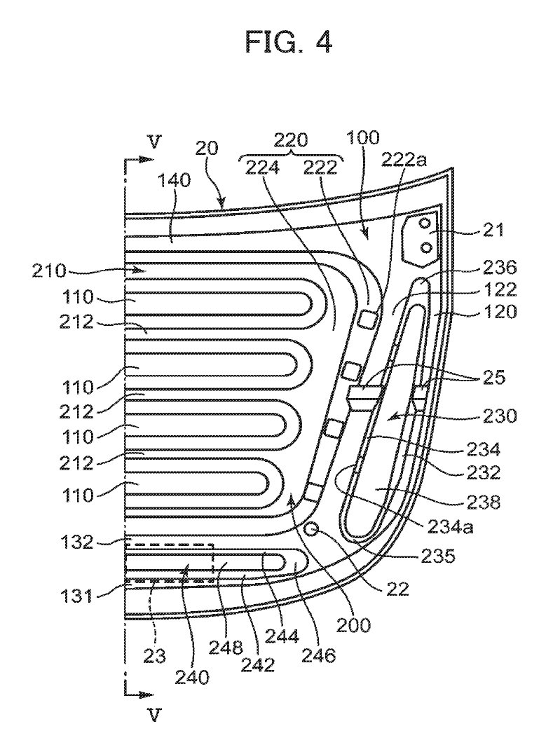

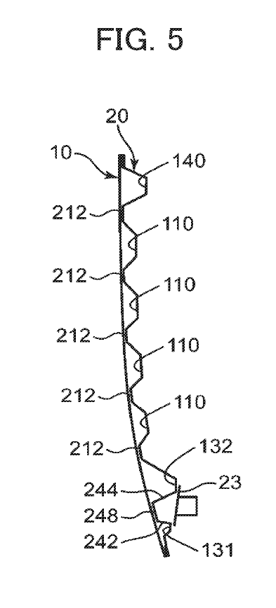

A vehicle hood of a second embodiment of the invention is now described with reference to FIGS. 4 and 5. In the second embodiment, only portions different from those of the first embodiment are described, and a structure, a function, and an effect, which are each the same as that in the first embodiment, are not described.

In the second embodiment, the bead bottom 100 further includes a most-front bottom 131 and a second-row bottom 132, and the beads 200 further includes a most-front bead 240.

The most-front bottom 131 is located in the most front in the longitudinal direction and has a shape extending in the breadth direction. The second-row bottom 132 is located behind the most-front bottom 131 (between the most-front bottom 131 and a central bottom 110 located in the most front among the central bottoms 110), and has a shape extending in the breadth direction.

The most-front bead 240 has a shape extending in the breadth direction between the most-front bottom 131 and the second-row bottom 132. The most-front bead 240 includes a most-front vertical wall 242, a second-row vertical wall 244, a lateral connection vertical wall 246, and a most-front opposing part 248.

The most-front vertical wall 242 has a shape rising from the most-front bottom 131 to the outer panel 10. The second-row vertical wall 244 has a shape rising from the second-row bottom 132 to the outer panel 10. The most-front vertical wall 242 and the second-row vertical wall 244 each have a shape inclining toward the other vertical wall as running toward the outer panel 10.

The lateral connection vertical wall 246 connects the lateral end of the most-front vertical wall 242 to the lateral end of the second-row vertical wall 244.

The most-front opposing part 248 connects the upper end of the most-front vertical wall 242 to the upper end of the second-row vertical wall 244 over the whole area in the breadth direction, and has a shape opposed to the lower surface of the outer panel 10.

In the second embodiment, as illustrated in FIG. 5, a striker and a striker reinforcement member 23 are disposed below the most-front opposing part 248. The most-front opposing part 248 is provided below the front end of the outer panel 10. Hence, when the front end of the outer panel 10 is pushed down toward the vehicle body, for example, when the vehicle hood is closed, a load exerted on the front end is received by the most-front opposing part 248; hence, a dent reinforcement member is omitted.

The cushion member seat 22 is provided in a region, which is behind the lateral connection vertical wall 246 and inside the front connection vertical wall 235, in a front corner of the inner panel.

In the second embodiment, since part of the load exerted between the outer bead 230 and the most-front bead 240 is received by both the front connection vertical wall 235 and the lateral connection vertical wall 246, stiffness of the inner panel 20 is increased.

### Third Embodiment

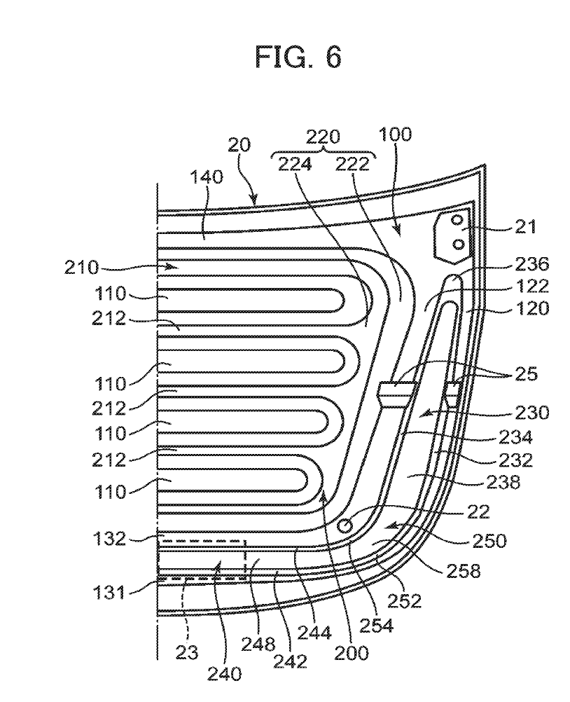

A vehicle hood of a third embodiment of the invention is now described with reference to FIG. 6. In the third embodiment, only portions different from those of the second embodiment are described, and a structure, a function, and an effect, which are each the same as that in the second embodiment, are not described.

In the third embodiment, the beads 200 further include a forward-angle bead 250 that connects the outer bead 230 to the most-front bead 240. The forward-angle bead 250 includes a forward-angle outer connection vertical wall 252, a forward-angle inner connection vertical wall 254, and a forward-angle opposing part 258. The forward-angle outer connection vertical wall 252 connects the outermost vertical wall 232 to the most-front vertical wall 242. The forward-angle inner connection vertical wall 254 connects the inner vertical wall 234 to the second-row vertical wall 244. The forward-angle opposing part 258 connects the outermost opposing part 238 to the most-front opposing part 248. Specifically, in the third embodiment, the front connection vertical wall 235 of the outer bead 230 and the lateral connection vertical wall 246 of the most-front bead 240 are omitted.

In the third embodiment, the outermost bottom 120 is smoothly connected to the most-front bottom 131 outside the forward-angle bead 250, and the inner bottom 122 is smoothly connected to the second-row bottom 132 inside the forward-angle bead 250.

In the third embodiment, the HIC score at each side can also be effectively decreased.

The embodiments disclosed herein should be considered to be exemplarily, but not limitedly, shown in all respects. The scope of the invention is defined by claims rather than the description of the embodiments, and includes all modifications and alterations in the sense equivalent to or within the scope of claims.

For example, the breadth direction of the outermost opposing part 238 does not limitedly have a shape that is increased in size in the breadth direction as running toward the front.

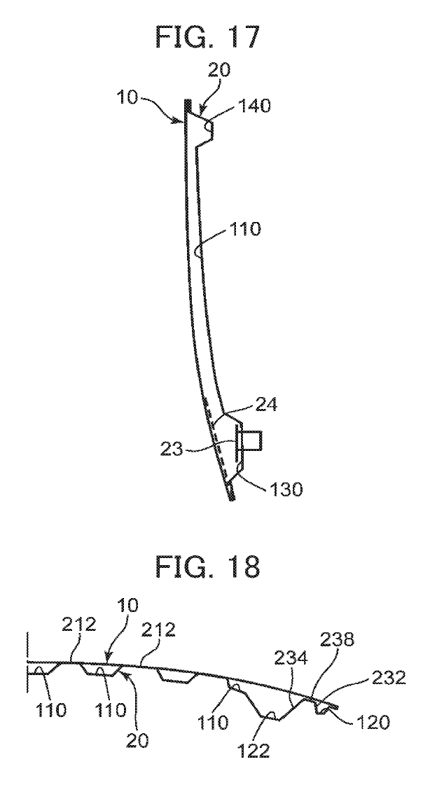

The central bottom 110 and the central bead 210 each do not limitedly have the shape shown in the above-described embodiments. For example, as illustrated in FIGS. 16 to 18, the central bottoms 110 are located above the inner bottom 122, the front bottom 130, and the rear bottom 140. The central beads 210 may be provided so as to each have a shape that protrudes from the central bottom 110 to the outer panel 10 and linearly extends along the longitudinal direction, and to be intermittently arranged in the breadth direction. In such an exemplary case, the central opposing parts 212 of the central beads 210 configure the mastic seat.

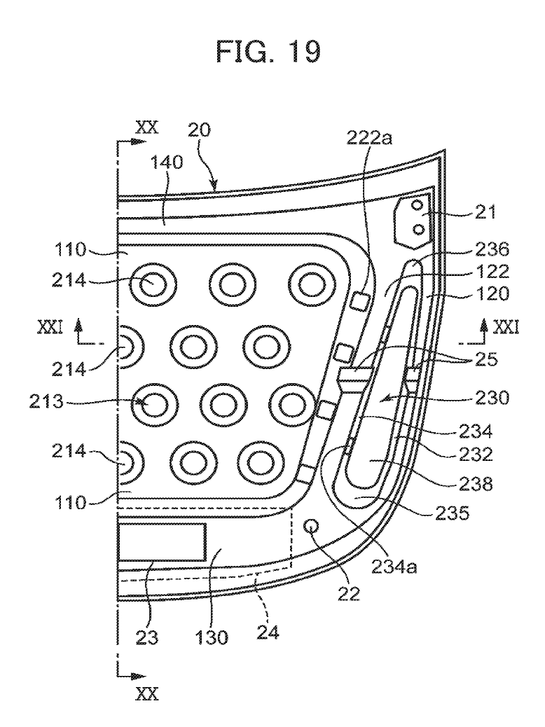

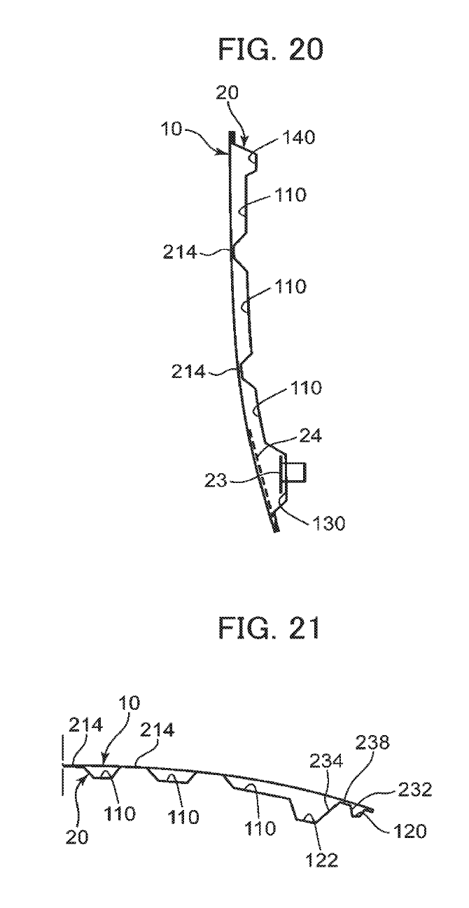

Alternatively, as illustrated in FIGS. 19 to 21, the central bottoms 110 are located above the inner bottom 122, the front bottom 130, and the rear bottom 140. The inner panel 20 may include a plurality of central protrusions 213 in place of the central beads 210. The central protrusions 213 each have a substantially truncated conical shape protruding from the central bottom 110 to the outer panel 10, and are intermittently arranged in the breadth direction and in the longitudinal direction. In this exemplary case, tops 214 of the central protrusions 213 configure the mastic seat.

### EXAMPLE

Evaluation of pedestrian protection performance under an E-NCAP child collision condition for the first embodiment is now described together with for a comparative example.

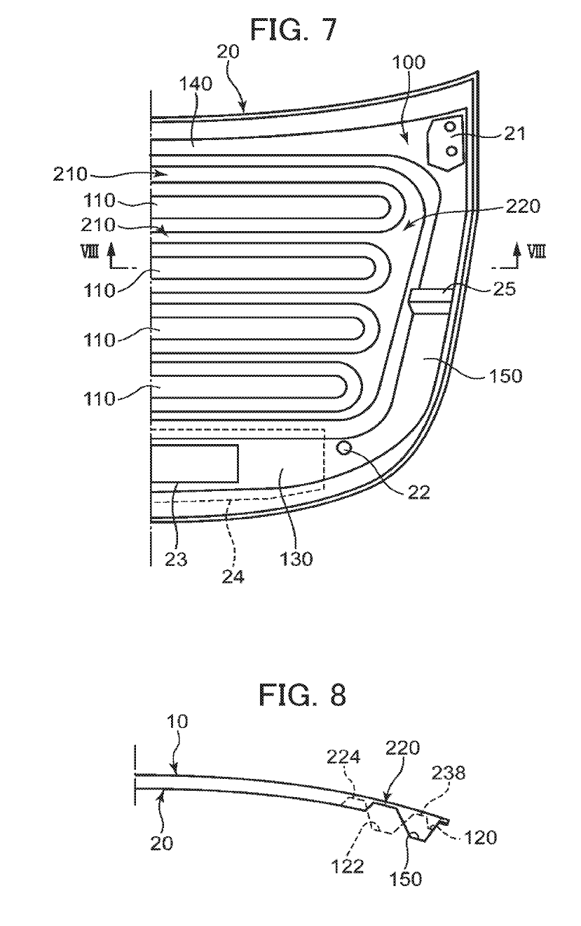

FIGS. 7 and 8 each illustrate a vehicle hood of a comparative example (existing structure). In the comparative example, although the central beads 210 and the connection bead 220 are provided, the outer bead 230 is not provided. As illustrated in FIG. 8, a connection opposing part of the connection bead 220 of the comparative example is provided at a position vertically overlapping with the inner bottom 122 of the first embodiment. A lateral bead bottom 150 in the comparative example is provided at a position vertically overlapping with the outermost opposing part 238 of the first embodiment. In FIG. 8, the inner panel 20 of the first embodiment is shown by a broken line.

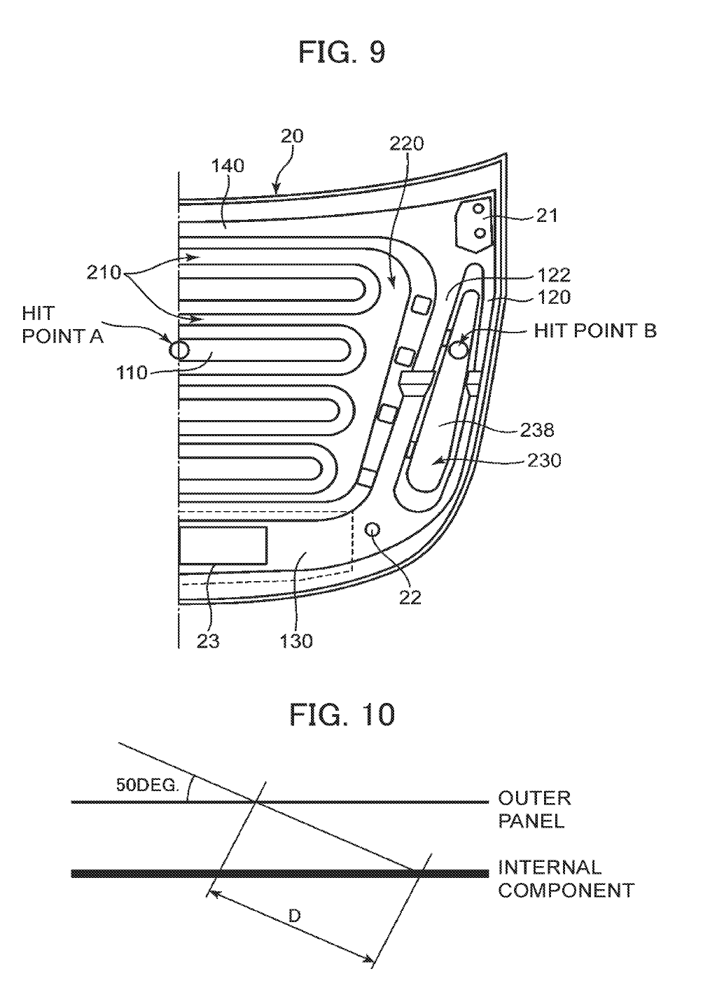

As illustrated in FIG. 9, the evaluation was performed at two points, i.e., a hit point A and a hit point B. The hit point A is a point in the middle in the breadth direction of the third central bottom 110 from the front. The hit point B is a point on the outermost opposing part 238, more specifically, the intersection between an extension of the central bottom 110, in which the hit point A is set, and the outermost opposing part 238. The evaluation was performed under the following condition: Impactor weight is 3.5 kg, collision speed is 40 km/h, a collision angle is 50°, and a gap D below a hood is 100 mm. As illustrated in FIG. 10, the collision angle means an angle defined by the outer panel 10 and a collision direction of the impactor, and the gap D below the hood means a distance between the outer panel 10 and an internal component in the collision direction.

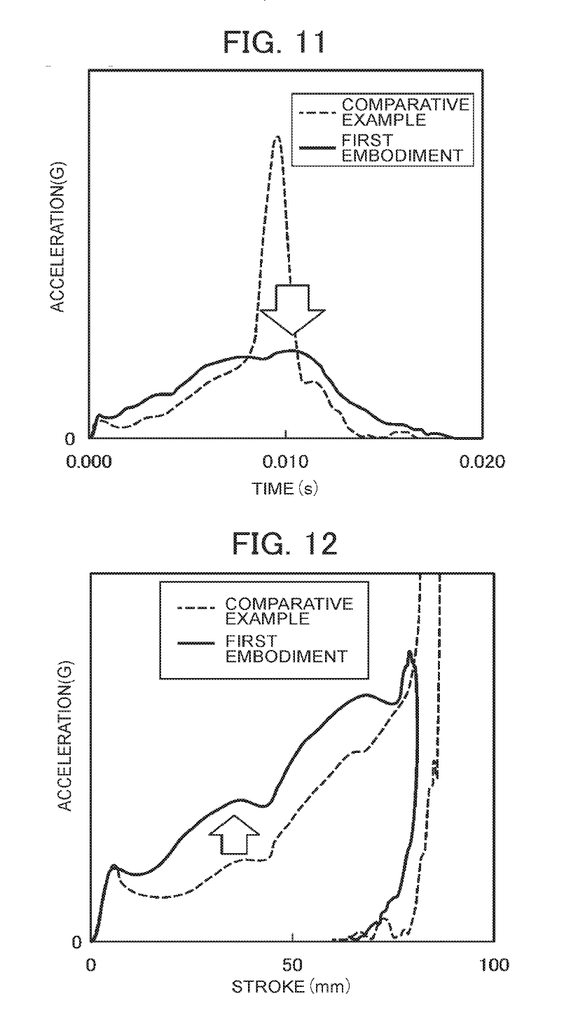

FIGS. 11 and 12 show results at the hit point B. FIG. 11 is a graph illustrating a relationship (acceleration secondary peak) between time and acceleration in the latter half of collision. FIG. 12 is a graph illustrating a relationship between a displacement stroke of the impactor and acceleration. These results reveal that the acceleration secondary peak is extremely lower in the first embodiment than in the comparative example. In addition, it is found that the HIC value in the first embodiment is decreased to ⅓ or less of that in the comparative example.

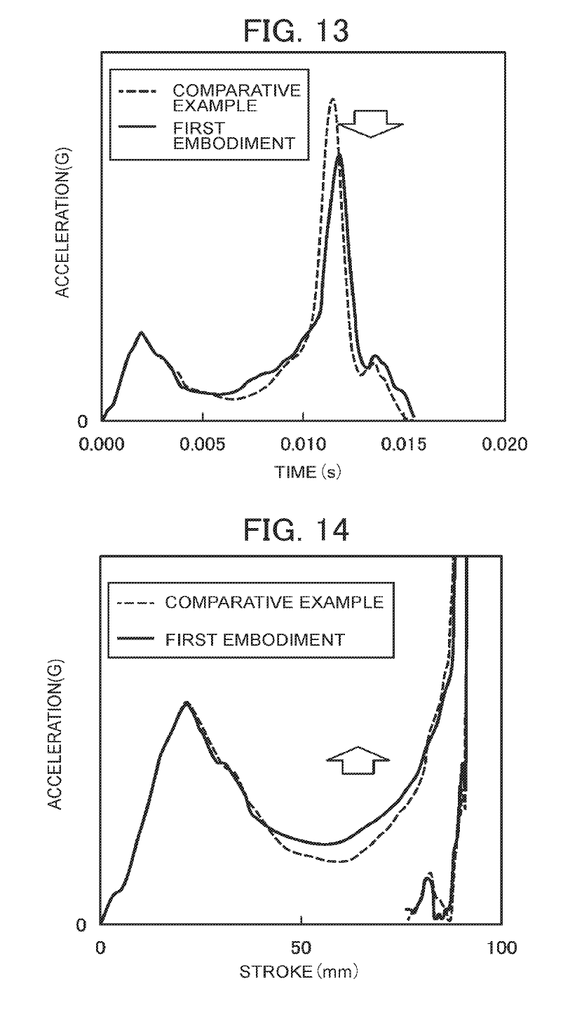

FIGS. 13 and 14 show results at the hit point A. FIG. 13 is a graph illustrating a relationship (acceleration secondary peak) between time and acceleration in the latter half of collision. FIG. 14 is a graph illustrating a relationship between a displacement stroke of the impactor and acceleration. These results reveal that the acceleration secondary peak is extremely lower in the first embodiment than in the comparative example. In addition, it is found that the HIC value in the first embodiment is decreased to about ⅔ of that in the comparative example.

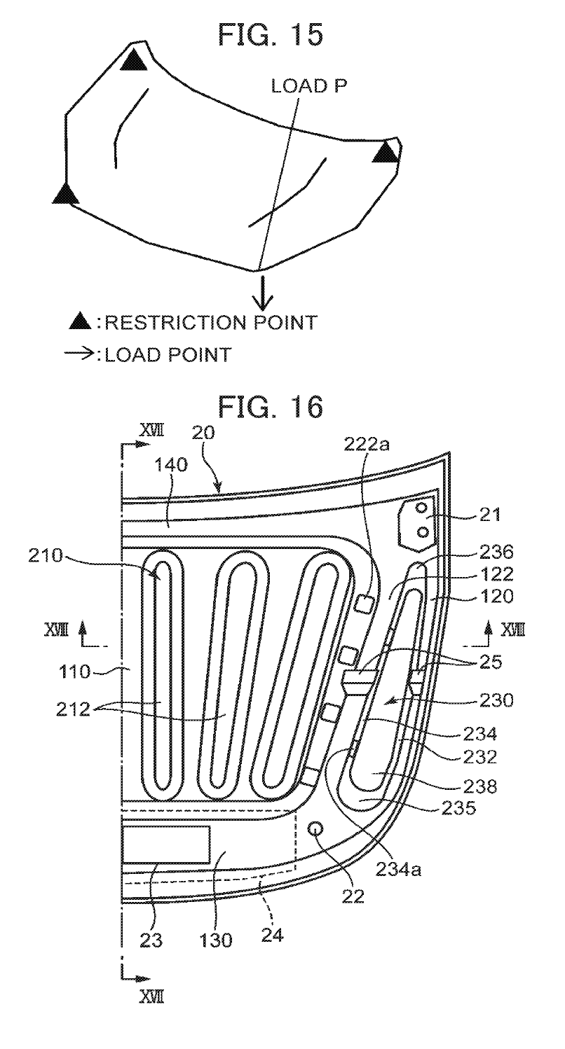

The torsional stiffness of the vehicle hood of this example was 4.0 N/mm, and the torsional stiffness of that of the comparative example was 2.5 N/mm. As illustrated in FIG. 15, the torsional stiffness was evaluated by exerting a load on one front corner while two rear corners and the other front corner are restrained.

This application claims priority to Japanese Patent Application No. 2015-237317, filed Dec. 4, 2015 and Japanese Patent Application No. 2016-136806, filed Jul. 11, 2016, the entirety of which is hereby incorporated by reference.

1. A vehicle hood, comprising:
an outer panel; and
an inner panel disposed below the outer panel,
wherein the inner panel includes
a bead bottom, and
a plurality of beads each having a shape protruding from the bead bottom toward the outer panel,
the bead bottom including
an outermost bottom that is located on an outermost side in a breadth direction and has a shape extending in a longitudinal direction, and
an inner bottom that is located inside the outermost bottom in the breadth direction and has a shape extending in the longitudinal direction,
the beads including a lateral bead having a shape extending in the longitudinal direction between the outermost bottom and the inner bottom,
the lateral bead including
an outermost vertical wall having a shape rising from the outermost bottom toward the outer panel,
an inner vertical wall having a shape rising from the inner bottom toward the outer panel, and
an outermost opposing part that connects an upper end of the outermost vertical wall to an upper end of the inner vertical wall over the whole area in the longitudinal direction, and is opposed to a lower surface of the outer panel.

2. The vehicle hood according to claim 1, wherein the outermost vertical wall has a shape inclining toward an inner side in the breadth direction as running toward the outer panel from the outermost bottom,
wherein the inner vertical wall has a shape inclining toward an outer side in the breadth direction as running toward the outer panel from the innermost bottom, and
wherein a distance between the outermost opposing part and the outermost bottom is set to be smaller than a distance between the outermost opposing part and the inner bottom.

3. The vehicle hood according to claim 2, wherein an inclination angle of the outermost vertical wall to the outermost bottom is set to be larger than an inclination angle of the inner vertical wall to the inner bottom.

4. The vehicle hood according to claim 1, wherein a hinge fixation part fixing a hinge is provided in a rear corner of the inner panel, the hinge fixation part connecting the vehicle hood to the vehicle body,
wherein a cushion member seat fixing a cushion member is provided in a front corner of the inner panel, and
wherein the inner bottom has a shape that extends along a straight line connecting the hinge fixation part to the cushion member seat.

5. The vehicle hood according to any one of claims 1 to claim 1, wherein the inner vertical wall has a trim hole penetrating through the inner vertical wall.

6. The vehicle hood according to claim 1, wherein the bead bottom further includes
a most-front bottom that is located in the most front in the longitudinal direction and has a shape extending in the breadth direction, and
a second-row bottom that is located behind the most-front bottom and has a shape extending in the breadth direction, and
wherein the beads further include a most-front bead having a shape extending in the breadth direction between the most-front bottom and the second-row bottom,
the most-front bead including
a most-front vertical wall having a shape rising from the most-front bottom to the outer panel,
a second-row vertical wall having a shape rising from the second-row bottom to the outer panel, and
a most-front opposing part that connects an upper end of the most-front vertical wall to an upper end of the second-row vertical wall over the whole area in the breadth direction, and is opposed to a lower surface of the outer panel.

7. The vehicle hood according to claim 6, further comprising a striker reinforcement member provided below the most-front opposing part.

8. The vehicle hood according to claim 6, wherein the outer bead further includes a front connection vertical wall that connects a front end of the outermost vertical wall to a front end of the inner vertical wall, and
wherein the most-front bead further includes a lateral connection vertical wall that connects a lateral end of the most-front vertical wall to a lateral end of the second-row vertical wall

9. The vehicle hood according to any one of claims 1 to claim 1, wherein the beads each have a shape extending along the breadth direction, and further include a plurality of central beads provided so as to be intermittently arranged in the longitudinal direction in the middle in the breadth direction.

10. The vehicle hood according to claim 9, wherein the beads further include a connection bead that connects the lateral ends in the breadth direction of the central beads to one another.

11. The vehicle hood according to claim 1, wherein each of the inner panel and the outer panel is formed of aluminum, and
wherein strength of the inner panel is set to be smaller than strength of the outer panel.
